(19) United States
(12) Patent Application Publication
(10) Pub. No.: US 2012/0228878 A1
(43) Pub. Date: Sep. 13, 2012

(54) Tidal Power Plant and Method for the Construction Thereof

(76) Inventors: Norman Perner, Neu-Ulm (DE); Wolfgang Maier, Nattheim (DE); Alexander Sauer, Heidenheim (DE); Benjamin Holstein, Heidenheim (DE)

(21) Appl. No.: 13/496,474

(22) PCT Filed: Sep. 15, 2010
(86) PCT No.: PCT/EP2010/005656

§ 371 Date: May 18, 2012

(30) Foreign Application Priority Data
Nov. 20, 2009 (DE) 102009053879.8

(51) Int. Cl. F03B 13/26; B21D 47/00

(52) U.S. Cl. 290/54; 29/897.3

(57) ABSTRACT

The invention relates to a tidal power plant, comprising a machine nacelle having a nacelle housing; a water turbine, which is part of a revolving unit, wherein the revolving unit is supported on the nacelle housing by means of a sliding bearing arrangement comprising a plurality of bearing elements. The invention is characterised in that the nacelle housing comprises at least one load-bearing concrete part and the bearing elements are adjustably fastened to the concrete part or to a bearing support cast into the concrete part.

The invention relates to a tidal power plant with the features contained in the preamble of claim 1 and a method for the construction thereof.

Tidal power plants which in their capacity as isolated units withdraw kinetic energy from running water or a tidal flow are known. One possible configuration provides a water turbine which is arranged in the manner of a propeller, comprises a horizontal rotational axis and revolves on a machine nacelle. A support structure is provided for the water turbine which is mounted radially on the outside on a barrel-shaped nacelle housing. Alternatively, a turbine shaft is attached to the water turbine, so that the associated bearings can be accommodated in the interior of the nacelle housing. Usually, axially spaced radial bearings and an arrangement of an axial bearing is used which is separated therefrom and which is configured for inflow of the water turbine on both sides. A bearing on both sides of a thrust collar on the turbine shaft can be provided.

In addition to the forces introduced by the bearings of the revolving unit, the supporting nacelle housing of a generic tidal power plant absorbs the force action of an electric generator driven by the water turbine. A support of the machine nacelle occurs in this case against a support structure reaching to the ground of the water body.

Nacelle housings configured up until now are provided with several parts and provide a stacked sequence of steel ring segments which are screwed together. This leads to high material and production costs as a result of the typically large overall size, so that alternative materials are considered for the production of a large number of installations. Fiber composites and seawater-proof concrete are proposed in addition to steel for a type of installation with an enclosed water turbine by WO 03/025385 A2 as materials performing an external flow housing. The external flow housing is used in addition to the flow guide for accommodating generator components which are arranged radially to the outside on the water turbine. The precisely arranged bearing arrangement of the water turbine is not applied to the external flow housing. Instead, the water turbine is supported via a turbine shaft bearing on a central element within the flow channel.

Furthermore, EP 2 108 817 A2 discloses a housing enclosure of a machine nacelle for a wind power plant, which housing enclosure is made of concrete. The wall thickness of the housing enclosure made of concrete is chosen with a thin wall in the range of 1 cm to 10 cm because the load introduction from the wind rotor and the subsequent drive train and the force action of the generator will be taken up by a separate support frame which rests directly on the tower of the wind power plant. Consequently, the forces on the turbine shaft are not dissipated by the concrete housing and it is provided instead with a noise protection function.

The invention is based on the object of providing a tidal power plant which is suitable for series production. This should lead to an installation which is permanently corrosion-proof in a seawater environment and which can be produced easily concerning its construction and production.

The object according to the invention is achieved by the features of the independent claims. Advantageous embodiments are provided by the dependent claims.

The nacelle housing of a machine nacelle is arranged for a tidal power plant in accordance with the invention as a load-bearing concrete part. The revolving unit with the water turbine is supported on the concrete nacelle housing by means of a sliding bearing arrangement which comprises a plurality of bearing elements, with the bearing elements being adjustably fastened directly to the concrete part or to bearing supports cast into the concrete part.

The concrete part for the nacelle housing can be arranged over wide sections without any special requirements being placed on the precision of the shape. In accordance with the invention, only the effective areas for the bearing arrangement of the revolving unit are arranged to offer precision of the contour. For this purpose, the concrete part of the nacelle housing is produced first. It can be arranged in an integral way, especially in a monocoque configuration, or it can consist of several concrete segments which are tensioned against one another. Subsequently, the bearing support points for the sliding bearing arrangement on the concrete part and/or on the bearing supports cast into the concrete part are measured with respect to their relative position. For the purpose of an advantageous embodiment, there will be in an optional intermediate step a customized reworking of the nacelle housing in the region of the bearing support points directly on the concrete part and/or on the cast bearing supports, followed by renewed measuring. The adjustable bearing elements are then fixed to the bearing support points and set up on the basis of the measurement data of the respective concrete part.

Accordingly, there is a three-step structuring of the requirements placed on the precision of the shape for the nacelle housing, wherein the basic contour of the concrete part can be produced in a relatively imprecise manner as the first stage. Deviations in the shape can occur especially during the joining and tensioning of concrete segments. They are merely relevant on the effective areas. The position of the support points on the nacelle housing are at least determined for the individual bearing segments for the sliding bearing arrangement of the revolving unit and are preferably reworked in a customized manner, so that in these areas an average accuracy of shape is achieved. This enables the fine adjustment by means of the adjustable bearing elements on the separate support points on the nacelle housing which forms the third step of the accuracy of the shape.

Seawater-proof concrete is used for the production of the concrete part and depending on the configuration of the nacelle housing the construction will be arranged as a reinforced prestressed-concrete part, as a composite of several concrete segments with prestressing elements, or in monocoque configuration. A fiber-reinforced concrete can be used and the concrete parts can comprise a sealing corrosion-protection coating.

Furthermore, the tensioning elements which are used to place the concrete part under pretension are protected against corrosion for use in a seawater environment. Inwardly disposed pass-through conduits can be provided alternatively or additionally in the concrete part, which are sealed or cast after the tensioning in such a way that tensioning elements contained therein will lie therein in a dry manner.

The turbine shaft is additionally arranged as a concrete part in a further development of the invention. For a preferred embodiment, the bearing components of the turbine shaft which form the sliding bearing surfaces are connected with one another by means of a steel frame, which forms a part of the armoring of the concrete part. The bearing components which are thereby fixed in position will then be introduced into a formwork and cast into concrete. Accordingly, the armoring in the concrete is thereby protected from corrosion. Furthermore, fibrous aggregates are added to the concrete which are corrosion-proof per se.

Furthermore, an arrangement of the concrete part for the turbine shaft is preferred which leads to a chosen setting of the lifting power and the lifting point relative to the center of gravity of the revolving unit in order to receive the sliding bearing arrangement. The turbine shaft is especially arranged to be floatable, so that a sealing of the concrete part must be provided which prevents the penetration of water into cavities or areas in the concrete part which are filled with floatable material.

An embodiment of the concrete part of the turbine shaft is especially preferred, for which a measurement is performed after the production at the interfaces to the adjacent components of the drive train. On this basis it is possible to adjust a connection piece on the turbine side and/or a connection piece on the generator side to the respective turbine shaft in a customized manner. Alternatively, the connection areas on the concreted turbine shaft are reworked.

Advantageously, a tidal power plant in accordance with the invention comprises several concrete segments which are tensioned against one another. As a result, every single one of the concrete segments can be processed individually. Moreover, the concrete segments can be arranged in such a way that there is a coaxial arrangement in the mounted state which forms an inwardly disposed annular groove for chambering a thrust collar on the turbine shaft. The annular groove is formed for an alternative embodiment by one or several boundary elements which are fastened to the inside wall on the concreted nacelle housing or to supports cast into the concrete.

The invention will be explained below in closer detail by reference to embodiments and in conjunction with the drawings which show in detail as follows:

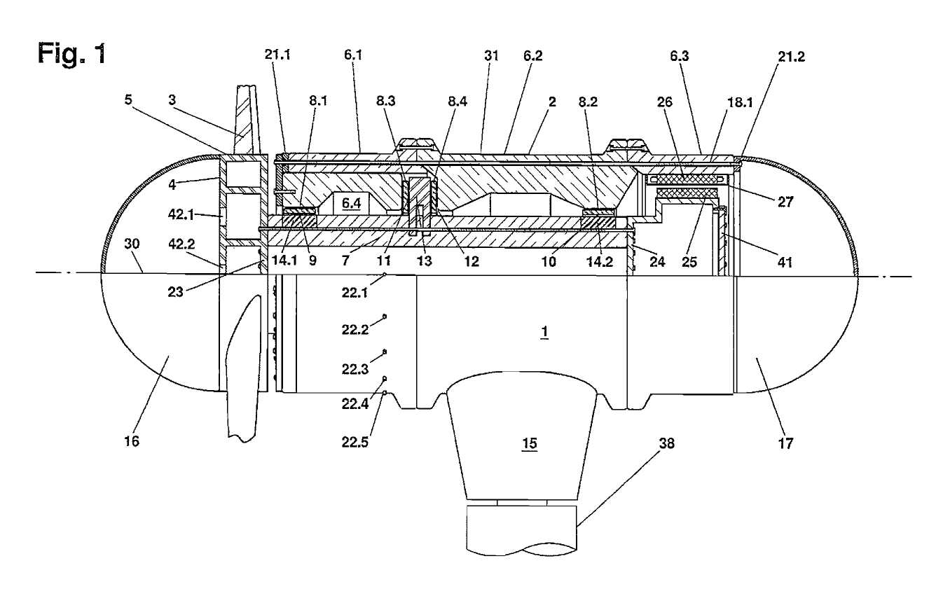

FIG. 1 shows a tidal power plant in accordance with the invention with a concreted nacelle housing in a partly sectional side view;

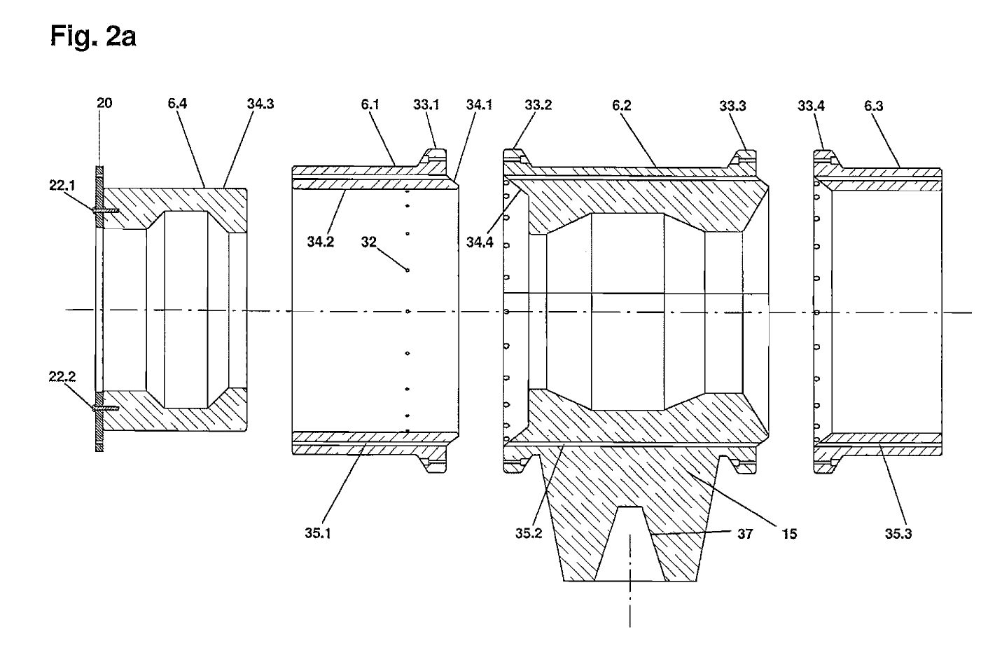

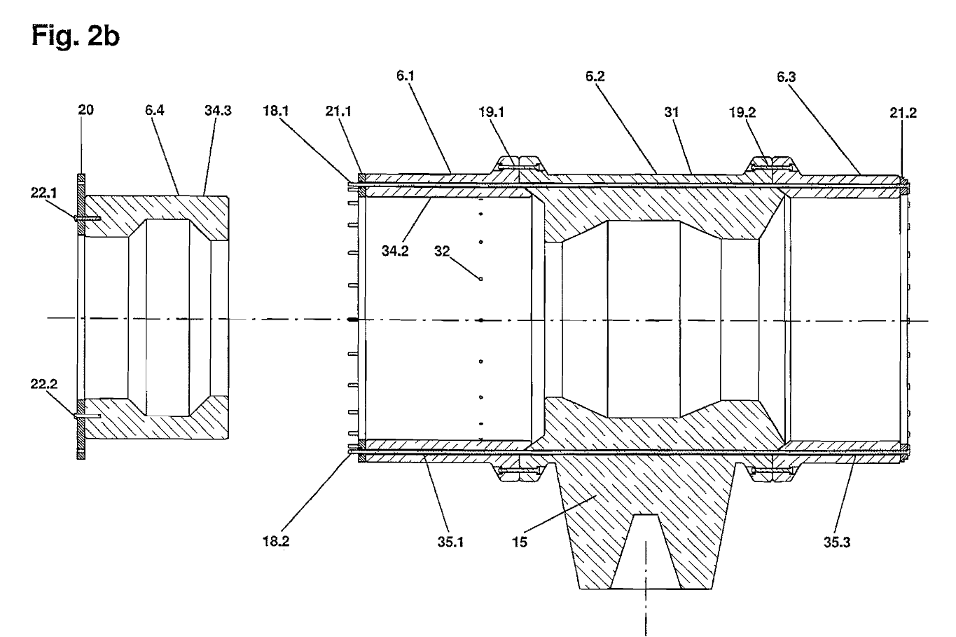

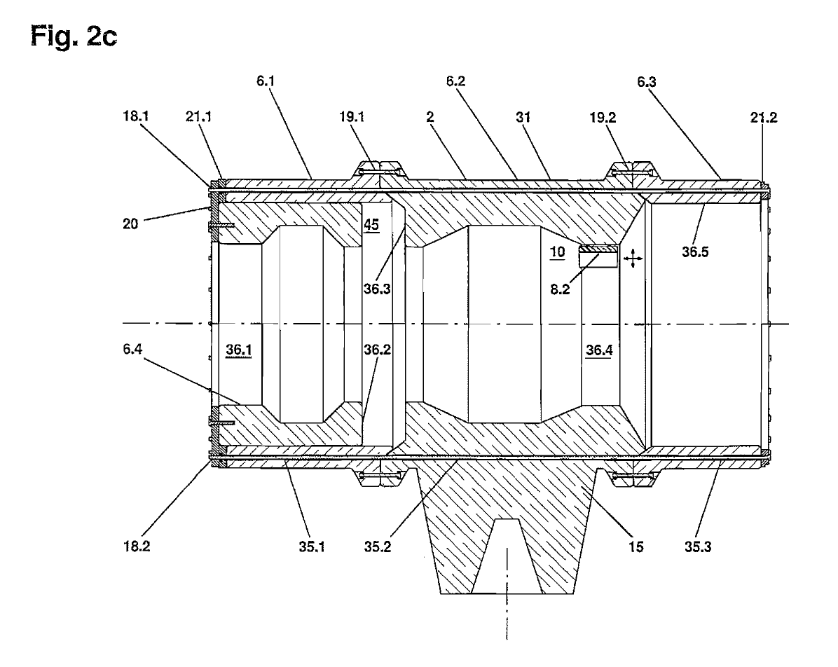

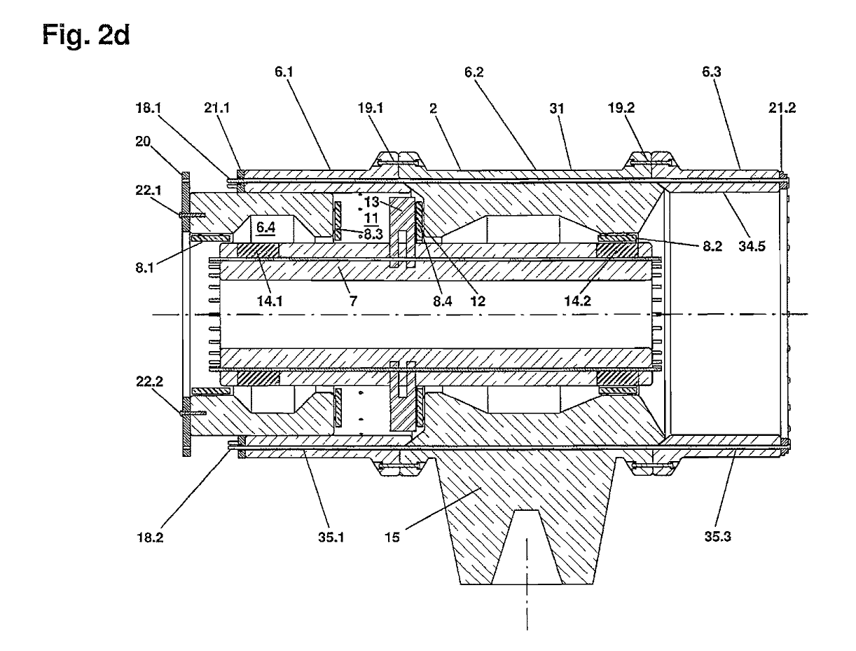

FIGS. 2a to 2d show an axial sectional view of the mounting of a nacelle housing in accordance with the invention, which is arranged as a concrete part with several concrete segments;

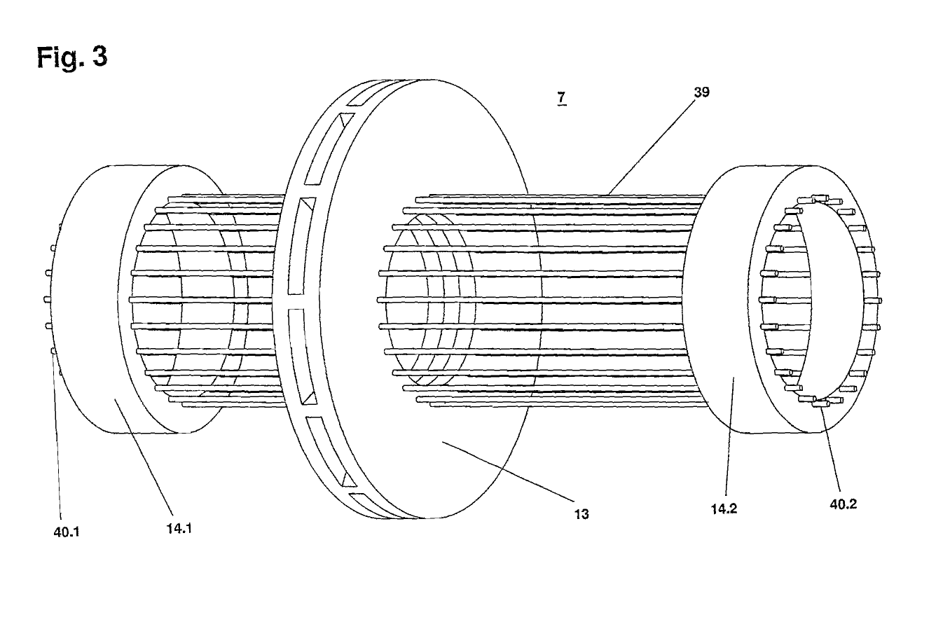

FIG. 3 shows a perspective view of parts of a turbine shaft for a further development of the invention in the state before the casting with concrete, with the sliding area components being connected by way of a steel frame.

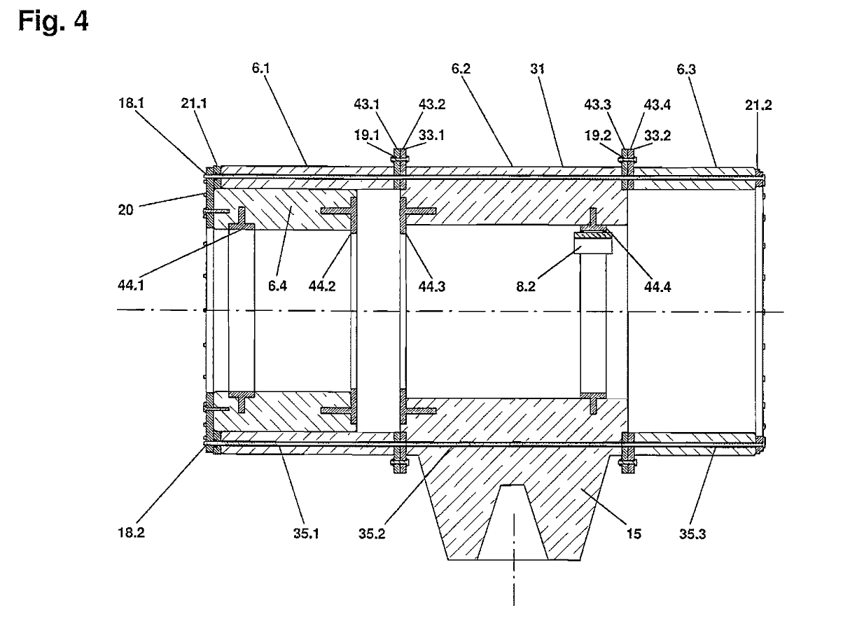

FIG. 4 shows an axial sectional view of an alternative embodiment of a concreted nacelle housing in accordance with the invention.

FIG. 1 shows a tidal power plant with a machine nacelle 1, comprising a load-bearing nacelle housing 2. The water turbine 3, the hood 16, the hub 5 and the turbine shaft 7 connected thereto in a torsion-proof manner form a revolving unit 4. The revolving unit 4 rests on the inside of the nacelle housing 2 by means of a sliding bearing arrangement. The turbine shaft 7 can be omitted for an alternative embodiment not shown in closer detail and instead an external rotor arrangement can be provided for the water turbine 3 with a support ring resting radially on the outside on the nacelle housing 2.

For the present embodiment, the sliding bearing arrangement comprises a first radial bearing 9, a second radial bearing 10, a first axial bearing 11 and a second axial bearing 12. Each of the aforementioned partial bearings comprises a plurality of bearing elements 8.1, 8.2, 8.3, 8.4, to which opposite sliding areas are assigned. The first radial bearing 9 comprises the sliding area component 14.1 on the turbine shaft 7. A further sliding area component 14.2 for the second radial bearing 10 is applied in an axially spaced manner therefrom. Furthermore, the bearing elements 8.3 and 8.4 of the first axial bearing 11 and the second axial bearing 12 slide on either side of a thrust collar 13, so that tensile and pressure forces in the axial direction, i.e. parallel to the rotational axis 30, can be caught for a bidirectional inflow on the water turbine 3.

In accordance with the invention, the load-bearing part of the nacelle housing 2 is arranged as a concrete part 31, with the bearing elements 8.1, 8.2, 8.3 and 8.4 being adjustably fastened to the concrete part 31. For a further alternative embodiment of the invention which will be explained below in closer detail in connection with FIG. 4, the bearing elements 8.1, 8.2, 8.3, 8.4 are adjustably fastened to bearing supports 44,1, 44.2, 44.3, 44.4 which are cast into the concrete part 31.

For the embodiment shown in FIG. 1, the concrete part 31 of the nacelle housing is arranged in several parts and comprises the tensioned concrete segments 6.1, 6.2, 6.3, 6.4. The advantage of a multi-part configuration from the large overall size of the nacelle housing 2 arises from the simplified handling ability and reworking capability of the individual concrete segments 6.1, 6.2, 6.3, 6.4. Moreover, a chambering for the thrust collar 13 can be realized, which will be explained below by reference to FIGS. 2a to 2c. Furthermore, the tower adapter 15, with which the machine nacelle 1 is fastened to a support structure 38, is also arranged as a concrete part for the preferred arrangement as shown in FIG. 1. The tower adapter 15 is part of the concrete segments 6.2 for the nacelle housing 2 in an especially advantageous way.

FIG. 2a shows the individual concrete segments 6.1, 6.2, 6.3, 6.4 in the premounted state, from which the nacelle housing is formed for the embodiment as shown in FIG. 1. The concrete segment 6.2 represents the middle part, on which the tower adapter 15 with the coupling apparatus 37 is integrally arranged. The respectively axially adjacent concrete segments 6.1, 6.2, 6.3 comprise contact areas which interlock into each other. The contact areas 34.1 and 34.4 in the region of the collars 33.1, 33.2 on the concrete segments 6.1, 6.2 are designated for this purpose by way of example. Moreover, an elastic element which is not shown in closer detail can be provided between adjacent contact areas 34.1, 34.4, which element will level out uneven portions. Furthermore, the channel sections 35.1, 35.2, 35.3 for the tension rods of the mutually adjacent concrete segments 6.1, 6.2, 6.3 are in alignment with each other. The flange connections arranged on the collars 33.1, 33.2, 33.3, 33.4 or the tension rods 18.1, 18.2 are used for a further preferred embodiment for connecting the concrete segments 6.1, 6.2, 6.3. This is not shown in closer detail in the drawings.

In addition, a concrete segment 6.4 is provided which is co-axially introduced into the concrete segments 6.1 for performing a chambering for the thrust collar. Accordingly, the radially inward contact area 34.2 on the concrete segment 6.1 and the radially outside contact area 34.3 on the concrete segment 6.4 are dimensioned for coming into contact with each other in the mounted state. A further development with an intermediate element not shown in closer detail is possible, which element facilitates the insertion of the concrete segment 6.4 into the concrete segment 6.1 on the one hand and compensates any unevenness in the shape of the contact areas 34.2, 34.3 by a certain amount of elastic deformability.

In addition to the positive connection, there is a non-positive and frictional connection between the concrete part 6.1 and 6.4 by means of the fastening elements 22.1 to 22.5 as shown in FIG. 1, which fastening elements reach radially from the outside through the concrete segment 6.1 up to the concrete segment 6.4. Bores are provided for this purpose in the concrete segment 6.1. One of these bores is provided with the reference 32 by way of example.

In a first mounting step which is shown in FIG. 2b, the connection of the concrete segments 6.1, 6.2, 6.3 which determine the basic shape of the nacelle housing 2 occurs first. Tension rods 18.1, 18.2 are provided in addition to the collar fixing elements 19.1, 19.2 for the present embodiment. The tension rods will tension the three concrete segments 6.1, 6.2, 6.3 between the two cover rings 21.1, 21.2 at the axial end surfaces of the concrete segments 6.1, 6.3. It is further shown that the tension rods 18.1, 18.2 on the concrete segment 6.1 protrude slightly beyond the cover ring 21.1, so that the ring flange 20 which is connected with the concrete segment 6.4 via the fastening elements 22.1, 22.2 can be fixed thereon.

A measurement of the bearings support points for the sliding bearing arrangement occurs for the method in accordance with the invention after the production of the load-bearing concrete part 31 for the nacelle housing. For the present embodiment, the measurement can occur after the joining and tensioning of the multipart structure of the concrete part (31). This state is shown in FIG. 2c. In comparison with FIG. 2b, the concrete segment 6.4 is additionally fastened to the already tensioned concrete segments 6.1, 6.2, 6.3, so that an inwardly disposed annular groove 45 is produced for the thrust collar 13. A customized reworking of the contact areas 34.2, 34.3 on the concrete segments 6.1 6.4 is preferably performed on the basis of measurement data obtained after the tensioning of the concrete segments 6.1, 6.2, 6.3.

Furthermore, the bearings support points 36.1, 36.2, 36.3 and 36.4 are measured with respect to the relative position and optionally reworked. It may be necessary for this purpose to disassemble the nacelle housing 2 back into individual segments, with a further measuring step generally having to occur after the renewed tensioning. The fixing and setup of the adjustable bearing elements 8.1, 8.2, 8.3 can subsequently be performed on the bearing support points 36.1, 36.2, 36.3, 36.4. The bearing element 8.2 is shown by way of example on the bearing support point 36.4, which is assigned to the second radial bearing 10.

FIG. 2d shows a further mounting step in which the turbine shaft 7 is introduced into the nacelle housing 2. Since the turbine shaft 7 comprises a thrust collar 13 for the illustrated embodiment, it is necessary to remove the coaxially inward concrete segment 6.4 before inserting the turbine shaft 7. The tensioning of the other concrete segments 6.1, 6.2, 6.3 via the tension rods 18.1, 18.2 between the cover rings 21.1, 21.2 and the collar fixing elements 19.1, 19.2 is maintained. FIG. 2d shows the renewed insertion of the concrete segments 6.4, with the bearing segment 8.3 of the first axial bearing 11 being guided on the one side against the thrust collar 13, which already rests on the opposite side on the bearing element 8.4 of the second axial bearing 12.

In a subsequent mounting step which is not shown in closer detail, the arrangement of the generator stator 26 on the concrete segment 6.3 occurs on the basis of the measurement of the contact area 34.5, which has optionally been reworked. Alternatively, the electric generator can be introduced in its entirety in the form of a pre-mounted unit into the concrete segment 6.3 and can be fastened to its inside wall.

The turbine shaft 7 is arranged as a concrete part in addition to the nacelle housing 2 for an especially preferred embodiment of the invention. For an advantageous embodiment which is outlined in FIG. 3, the components of the first radial bearing 9 and the second radial bearing 10 which are precisely positioned with respect to each other, especially the sliding area components 14.1, 14.2, and the thrust collar 13 are connected via a steel frame 39 which forms a part of the armoring. It is cast into concrete in a subsequent production step. Especially preferably, the end pieces 40.1, 40.2 of the steel frame 39 protrude beyond the turbine shaft 7 at the two axial front faces. The individual components of the end pieces 40.1, 40.2 are provided with threads, so that—as is shown in FIG. 1—a connection piece 23 on the turbine side, which in this case is an axial area of the hub 5 facing the turbine shaft 7, and a connection piece 24 on the generator side which is used as a support for the generator rotor 25 can be inserted and screwed together. Preferably, there will be a customized adjustment to the model of the connection elements on the end pieces 40.1, 40.2 which is present after the production. For mounting purposes, there will be an engagement via the access openings 42.1, 42.2 on the connection piece 24 on the generator side with a subsequent insertion of the hood 16 on the rotor side. Accordingly, the individually adjusted connection piece 24 on the generator side can be reached via an access opening which is sealed after mounting with the cover 41 shown in FIG. 1. The hood 17 on the generator side is finally inserted.

The inside area of the turbine shaft 7 is preferably encapsulated in a waterproof manner in the final mounting state, so that the turbine shaft 7 is arranged to be floatable for relieving the sliding bearing arrangement. The sealing elements which are especially provided for this purpose in the region of the connection piece 23 on the turbine side and the connection piece 24 on the generator side are not shown in closer detail in the drawings.

FIG. 4 shows an alternative arrangement for a nacelle housing in accordance with the invention. Deviating from the embodiments as shown above, the collars 33.1, 33.2 are formed by flange elements 43.1, 43.2, 43.3, 43.4 which are cast in the respective concrete segment 6.1, 6.2, 6.3, 6.4 and are preferably arranged as steel rings. Furthermore, there are bearing supports 44.1, 44.2, 44.3, 44.4 which are preferably also made of a corrosion-proof steel. They are cast into the concrete segments 6.2 and 6.4 and are measured and optionally reworked after the production of the concrete part in accordance with the method in accordance with the invention. The advantage of cast bearing supports 44.1, 44.2 of 44.3, 44.4 is the simplification of the reworking step in conjunction with a higher processing quality. Moreover, the local loads on the fastening points of the bearing elements 8.1, 8.2, 8.3, 8.4 can be better compensated.

Further embodiments of the invention are possible, wherein especially parts of the nacelle housing 2 can be made of non-concrete parts, so that the load-bearing concrete composite part is generally produced. Further embodiments of the invention are obtained from the following claims.

### LIST OF REFERENCE NUMERALS

1 Machine nacelle

2 Nacelle housing

3 Water turbine

4 Revolving unit

5 Hub

6.1, 6.2, 6.3, 6.4 Concrete segment

7 Turbine shaft

8.1, 8.2, 8.3, 8.4 Bearing element

9 First radial bearing

10 Second radial bearing

11 First axial bearing

12 Second axial bearing

13 Thrust collar

14.1, 14.2 Sliding area component

15 Tower adapter

16 Hood on the rotor side

17 Hood on the generator side

18.1, 18.2 Tension rod

19.1, 19.2 Collar fixing element

20 Ring flange

21.1, 21.2 Cover ring

22.1, 22.2, 22.3, 22.4, 22.5 Fastening element

23 Connection piece on the turbine side

24 Connection piece on the generator side

25 Generator rotor

26 Generator stator

27 Can of a motor

28.1, 28.2, 28.3 Cast bearing support

30 Rotational axis

31 Concrete part

32 Bore

33.1, 33.2 Collar

34.1, 34.2, 34.3, 34.4, 34.5 Contact area

35.1, 35.2, 35.3 Channel sections for the tension rods

36.3, 36.4 Bearing support point

37 Coupling apparatus

38 Support structure

39 Steel frame

40.1, 40.2 End piece

41 Cover

42.1, 42.2 Access openings

43.1, 43.2, 43.3, 43.4 Flange element

44.1, 44.2, 44.3, 44.4 Bearing support

45 Annular groove

1-16. (canceled)

17: A tidal power plant, comprising
a machine nacelle with a nacelle housing;
a water turbine which is part of a revolving unit, with the revolving unit resting on the nacelle housing by means of a sliding bearing arrangement comprising a plurality of bearing elements;
characterized in that
the nacelle housing comprises at least one load-bearing concrete part and the bearing elements are adjustably fastened to the concrete part or to a bearing support cast into the concrete part.

18: The tidal power plant according to claim 17, characterized in that the concrete part is reworked in a region to which the bearing elements have been fastened.

19: The tidal power plant according to claim 17, characterized in that the bearing support consists of a material which is corrosion-proof in a seawater environment.

20: The tidal power plant according to claim 18, characterized in that the bearing support consists of a material which is corrosion-proof in a seawater environment.

21: The tidal power plant according claim 17, characterized in that the concrete part comprises several concrete segments.

22: The tidal power plant according claim 18, characterized in that the concrete part comprises several concrete segments.

23: The tidal power plant according claim 19, characterized in that the concrete part comprises several concrete segments.

24: The tidal power plant according claim 20, characterized in that the concrete part comprises several concrete segments.

25: The tidal power plant according to claim 24, characterized in that tension rods which are used for tensioning the concrete segments extend in water-proof encapsulated tension-rod channel sections in the interior of the concrete segments and/or carry an anti-corrosion coating and/or consist of a corrosion-proof material.

26: The tidal power plant according claim 17, characterized in that the nacelle housing comprises an inwardly disposed annular groove which is formed by coaxially arranged annular concrete segments and/or several boundary elements which are fastened on the inside wall to the concreted nacelle housing or to cast supports.

27: The tidal power plant according to claim 24, characterized in that at least two concrete segments comprise cast flange elements for mutual fastening.

28: The tidal power plant according to claim 17, characterized in that the bearing arrangement comprises a first radial bearing on a first concrete segment and a second radial bearing on a second concrete segment, with the first concrete segment and the second concrete segment being tensioned at least indirectly against one another.

29: The tidal power plant according to claim 17, characterized in that the concrete part consists of seawater-proof concrete.

30: The tidal power plant according to claim 17, characterized in that the concrete part comprises fiber concrete.

31: The tidal power plant according to claim 17, further comprising a turbine shaft as a part of the revolving unit which is arranged as a concrete part.

32: The tidal power plant according to claim 31, characterized in that the turbine shaft comprises sliding area components which are cast into the concrete part.

33: The tidal power plant according to claim 32, characterized in that the sliding area components are connected with one another by means of a steel frame which forms a part of the armoring of the concreted turbine shaft.

34: The tidal power plant according to claim 31, characterized in that the turbine shaft is sealed against the penetration of water and forms a floatable part of the revolving unit.

35: The tidal power plant according to claim 31, further comprising a connection piece on the turbine side and/or a connection piece on the generator side, which are adjusted in a customized manner to the turbine shaft present in the individual tidal power plant.

36: A method for producing a nacelle housing of a tidal power plant, on which rests a revolving unit with a water turbine by means of a sliding bearing arrangement comprising a plurality of bearing elements, characterized by the following method steps:
production of the load-bearing part of the nacelle housing as a concrete part;
measuring bearing support points for the bearing elements on the concrete part and/or on at least one bearing support cast into the concrete part;
fixing and setup of adjustable bearing elements on the bearing support points.
